(19) United States
(12) Patent Application Publication
(10) Pub. No.: US 2026/0352144 A1
(43) Pub. Date: Nov. 5, 2026

(54) SOLAR INSTALLATION COMPRISING SUSPENDED SOLAR PANELS

(71) Applicant: POMA, Voreppe (FR)

(72) Inventor: Mathieu BABAZ, Saint-Étienne-de-Crossey (FR)

(73) Assignee: POMA, Voreppe (FR)

(21) Appl. No.: 19/656,925

(22) Filed: Apr. 23, 2026

(30) Foreign Application Priority Data
Apr. 30, 2025 (FR) FR2504600

(51) Int. Cl. H02S 20/32; F24S 30/425; H02S 20/10; F24S 30/00; F24S 50/20; F24S 50/40; F24S 50/60; F24S 50/80

(52) U.S. Cl. CPC H02S 20/32; F24S 30/425; H02S 20/10; F24S 2030/133; F24S 2030/136; F24S 50/20; F24S 50/40; F24S 50/60; F24S 50/80

(57) ABSTRACT

A solar installation including a support structure including a supporting structure and a row of panels, each of the panels being laterally suspended by the supporting structure, the row of panels including at least one first sub-assembly of tiltable panels, which are tiltable and which each include at least one photovoltaic and/or solar thermal active element, the row of panels including at least one second sub-assembly of tiltable panels, which are each tiltable at least between a covering position and an open position, the first and second sub-assemblies of tiltable panels being separate.

### CROSS-REFERENE TO RELATED APPLICATION

This application claims priority under 35 U.S.C. § 119(b) from French Patent Application No. 2504600, filed Apr. 30, 2025; the disclosure of which is incorporated herein by reference in its entirety.

### TECHNICAL FIELD OF THE INVENTION

The invention relates generally to the field of solar installations comprising solar, photovoltaic or solar thermal panels suspended from a structure, in particular cables.

In addition, the invention relates to the fields of ground cover structures for managing solar exposure, rainwater or frost exposure, for example in agriculture or in urban environments.

### BACKGROUND

Document EP 4362323 discloses a solar installation comprising a support having two support cables and photovoltaic panels supported by said cables, the panels forming a row of panels. The photovoltaic panels are spaced apart by a predetermined distance and can be tilted, that is, moved, simultaneously in the same direction. A disadvantage of such a solar installation is the inability to manage the panels distinctly according to their assigned position along the row of panels, for example when the row of panels follows two distinct sloping lines. The orientation of the panels towards the sun is then not optimized based on the positioning of each panel along the row.

In addition, other disadvantages arise from this solar installation, for example the inability to manage rainwater where runoff is not directed, or to protect partially covered ground from frost. This solution is then not suitable for agricultural applications, for example.

To overcome this problem, document US 2024/243692, for example, proposes a solar installation comprising a row of photovoltaic panels superimposed like roof shingles. In this way, the row of panels forms a continuous cover, protecting the ground and directing rainwater runoff. These panels are nevertheless fixed. Indeed, it is complicated to orientate panels when they cannot pivot freely because one or more adjacent panels restrict their rotational movements.

This configuration generates risks of deterioration of the panels depending on weather conditions (hail, strong gusts), and is not optimized in terms of energy production yield due to the fixed orientation of the panels and, optionally, the yield of agricultural land located below these rows of panels, due to excessive shading reducing the sun exposure time of the plants on the land.

### SUMMARY

The invention aims to overcome all or some of the disadvantages of the prior art and to propose a solar installation whose tiltable panel orientation is optimized, so that the row of panels is better adapted and adaptable to its environment.

To this end, according to a first aspect of the invention, a solar installation is proposed comprising a support structure comprising a supporting structure parallel to a reference direction, and a row of panels arranged along the reference direction, each of the panels being suspended laterally by the supporting structure, the row of panels comprising at least a first subset of tiltable panels, which are each tiltable at least between a covering position and an open position by pivoting about a pivoting axis perpendicular to the reference direction and which each comprise at least one photovoltaic and/or solar thermal active element, a first pivot control cable extending parallel to the reference direction being connected to the tiltable panels of the first sub-assembly of tiltable panels, the solar installation being characterized in that the row of panels comprises at least one second sub-assembly of tiltable panels, which are each tiltable at least between a covering position and an open position by pivoting about a pivoting axis perpendicular to the reference direction, a second pivoting control cable extending parallel to the reference direction being connected to the tiltable panels of the second sub-assembly of tiltable panels, the first and second sub-assemblies of tiltable panels being separate.

The two sub-assemblies then can be handled separately. This allows two different rotations to be applied to any two successive tiltable panels (according to their direction or their amplitude of rotation). Thus, it is possible to better modulate the shading cast onto a plane below the solar installation. For example, in hot, sunny weather, it is preferable to shade the area below the installation as much as possible, if said area is a parking lot. By contrast, if said area is an agricultural field comprising plantations requiring high levels of sunlight, it is preferable for the cast shade to be minimal. Thus, with two separate sub-assemblies, it is possible to adapt the position of the tiltable panels to optimize the solar energy that is recovered, while modulating the shading according to the environment in which the solar installation is installed.

Also, the use of two strands of control cable to orientate the sub-assemblies of tiltable panels optimizes the modulation of the shading that is generated, reducing the cost of this modulation, since it is not necessary to motorize each tiltable panel independently.

According to one embodiment, the supporting structure comprises two support cables, the two support cables extending parallel to the reference direction. This reduces the production costs of the solar installation, since the supporting structure formed by support cables is lighter and simpler to produce than a structure comprising beams, for example.

According to one embodiment, each support cable is equipped with several pivots, with these pivots being arranged so that each pivot of a support cable has a corresponding pivot on the other support cable, thus forming pairs of pivots aligned on a single pivoting axis and associated with the panel associated with said axis.

Alternatively, the supporting structure comprises pylons each associated with one of the panels, via a pivot, which can be positioned, for example, at the center of gravity of the associated panel.

According to one embodiment, in the covering position, the row of panels forms a continuous cover. In the covering position, the installation forms a continuous covering over the ground, protecting the ground from precipitation or radiative ground cooling in winter, for example. Such a solution can be particularly advantageous when the installation covers a parking lot, or in the agricultural sector, especially when the ground beneath the installation is a field containing plants and/or animals and/or treatment agents that are sensitive to water, and therefore rain. The installation then causes water to run off the row of panels towards a lower point, keeping the field below dry.

According to one embodiment, in the covering position, the tiltable panels partially overlap and form a shingle arrangement along the reference position. The shingle arrangement provides a better watertight seal between two successive tiltable panels, and therefore improves rainwater runoff to increase protection of the area below the row of panels.

Alternatively, in the covering position, the tiltable panels come into contact with each other without overlapping along the reference direction. It is therefore preferable for each panel to include a seal at its ends, so that the interface between two panels can be sealed. Such a row of tiltable panels covers a larger surface, with the same number of panels, than when the row forms a roof shingle.

According to another embodiment, in the covering position, the tiltable panels are spaced apart from each other. Such an arrangement does not allow the underlying surface to be completely concealed, but, like the previous ones, allows the two sub-assemblies of tiltable panels to be set at different angles.

If required, the installation can include water collectors, for example, gutters, and especially gutters positioned on the edges of the tiltable panels parallel to the pivoting axis. Water collectors allow any water flows to be directed to a destination other than that indicated by the slope of the row of panels, often inherited from the natural slope of the environment where the solution is installed. These water collectors can be integrated, for example, into the aforementioned seals in the installation featuring the row of tiltable panels where said panels do not overlap and are joined end-to-end.

According to one embodiment, the reference direction is at least locally parallel to a line of the greatest slope of the ground on which the support structure is fixed. The solar installation then has at least one portion in which the row of tiltable panels is inclined (and thus forms an acute angle with a horizontal plane). In other words, the centers of gravity of two successive tiltable panels of the same sub-assembly are located at different altitudes.

According to another embodiment, the reference direction is at least locally parallel to a level line. The solar installation then has at least one portion in which the row of tiltable panels is parallel to the horizontal plane. In other words, the centers of gravity of two successive tiltable panels of the same sub-assembly are located at the same altitude.

According to one embodiment, the first sub-assembly follows a first line of greatest slope and the second sub-assembly follows a second line of greatest slope, with the first line of greatest slope and the second line of greatest slope forming a non-flat angle, preferably an angle greater than or equal to 110°, even more preferably an angle less than or equal to 170°.

In such an arrangement, the installation is particularly advantageous, allowing, when the first sub-assembly is the one associated with one of the two greater slopes and the second sub-assembly is the one associated with the other one of the two greater slopes, the inclination of each of the two sub-assemblies to be optimized so that their associated tiltable panels are optimally oriented in the desired direction according to requirements.

According to one embodiment, any two successive tiltable panels of the first sub-assembly of tiltable panels are separated by a tiltable panel of the second sub-assembly of tiltable panels, and any two successive tiltable panels of the second sub-assembly of tiltable panels are separated by a tiltable panel of the first sub-assembly of tiltable panels. The tiltable panels of the two sub-assemblies therefore alternate.

According to one embodiment, the active elements can be bifacial, in the sense that they are able to produce electrical or thermal energy both in response to incident radiation on their upper face and in response to incident radiation on their lower face.

According to one embodiment, the tiltable panels of the second sub-assembly of tiltable panels each comprise at least one photovoltaic and/or solar thermal active element. This embodiment allows the surface area of active elements to be extended, allowing energy to be generated from light or solar energy. It also has the advantage of increasing the shading cast onto the area below the row of tiltable panels.

According to another embodiment, at least some of the tiltable panels of the second sub-assembly of tiltable panels do not include photovoltaic and/or solar thermal active elements. These panels then can be concealing or transparent panels, as required.

According to one embodiment, these panels are reflective. These can especially be mirrors.

According to one embodiment, the row of panels comprises at least one sub-assembly of non-concealing panels, each comprising at least one fully transparent portion which, in the covering position, allows incident light to pass through said non-concealing panels, with the sub-assembly of non-concealing panels being able to include all or part of the first sub-assembly of tiltable panels and/or the second sub-assembly of tiltable panels.

Thus, the shading cast behind the panels is reduced. More particularly, the shading is completely canceled out locally behind a transparent tiltable panel. Thus, incident light energy passes through the transparent panel and, depending on the inclination of the sun, reaches the ground or an adjacent panel. When the tiltable panels are oriented in a predetermined direction with respect to the sun, an incident beam can pass through the transparent tiltable panel and reach an adjacent tiltable panel featuring at least one photovoltaic and/or solar thermal active element. This embodiment is particularly advantageous when the panels form a shingle arrangement, insofar as it allows continuous coverage in the covering position to be reconciled with good sunshine for the active elements.

Preferably, in the covering position, the fully transparent portion of at least one of the tiltable panels of the sub-assembly of non-concealing panels is adjacent to an active element of an adjacent tiltable panel of the row of panels.

Thus, despite a partial overlap between two successive tiltable panels and two strands of control cables allowing two tiltable panel sub-assemblies to be distinctly oriented, irrespective of the overlapping hierarchy, the active element of an associated tiltable panel will never be shaded by an adjacent tiltable panel.

According to one embodiment, the first sub-assembly of tiltable panels and the sub-assembly of non-concealing panels have an intersection that is not empty, with the first sub-assembly of tiltable panels preferably being included in the sub-assembly of non-concealing panels. In this case, at least some, and, if applicable, all, of the panels of the first sub-assembly, which by definition each comprise at least one photovoltaic and/or solar thermal active element, further comprise at least one fully transparent portion. Thus, despite the shingle arrangement of the entire row of tiltable panels, the active element of an associated tiltable panel will never be shaded by an adjacent tiltable panel.

According to one embodiment, the second sub-assembly of tiltable panels and the sub-assembly of non-concealing panels have an intersection that is not empty, with the second sub-assembly of tiltable panels preferably being included in the sub-assembly of non-concealing panels. The panels of the second sub-assembly can be, in this case, either fully transparent or partially transparent, and, like the panels of the first sub-assembly, can include a photovoltaic and/or solar thermal active element.

In the case whereby the tiltable panels of the first and second sub-assemblies are identical, for example, when each panel comprises a surface comprising an active element between two transparent portions, the installation allows the surface area of active elements included in the row of tiltable panels to be optimized, while maintaining a continuous seal in the covering position, whether or not the adjacent panels overlap.

According to one embodiment, the first sub-assembly comprises tiltable panels comprising the active elements and no transparent elements, and the second sub-assembly comprises tiltable panels comprising the transparent elements and not comprising active elements. In particular, the tiltable panels of the first sub-assembly can be fully concealing and fully covered by their photovoltaic or solar thermal active element, while the panels of the second sub-assembly can be fully transparent.

According to one embodiment, the pivoting axis passes through the center of gravity of the associated tiltable panel. Thus, the power required to pivot each tiltable panel is minimal.

According to one embodiment, the installation comprises at least one first motor for pulling the first control cable. According to a first variant, the first control cable forms a closed loop of cable stretched between two end pulleys, and can be equally pulled in either direction by a single first motor. Alternatively, according to a second variant, the first cable belongs to an open cable whose two ends are pulled by two first motors.

According to one embodiment, the installation comprises at least one second motor for pulling the second control cable. In a first variant, the second control cable forms a closed cable loop stretched between two end pulleys, and can be equally pulled in either direction by a single second motor. Alternatively, according to a second variant, the second cable belongs to an open cable whose two ends are pulled by two second motors.

According to one embodiment, the installation comprises a control device capable of controlling the first motor and, if applicable, the second traction motor as a function of one or more signals from one or more sensors, preferably selected from among the following sensors: a brightness sensor; a humidity sensor; a movement sensor; a position sensor; an electric current or voltage sensor placed in a circuit comprising at least one active element of at least one of the tiltable panels of the first sub-assembly.

The installation is then automated, and can be adapted to environmental conditions, with one or a combination of the aforementioned sensors detecting wind or hail, for example.

According to another aspect of the invention, it also relates to a method for controlling a solar installation as described above, the method being characterized in that it comprises a step of pulling the first control cable, so as to drive the rotation of the first sub-assemblies associated with said control cable.

According to one embodiment, the method comprises a step of pulling the second cable, so as to drive the second control cable.

According to one embodiment, from the covering position, it comprises an opening sequence comprising:
a step of pulling the first cable in a first direction, causing the panels of the first sub-assembly to pivot in a first direction of rotation; then
a step of pulling the second cable in a second direction, causing the panels of the second sub-assembly to pivot in a second direction of rotation; then
a step of pulling the first cable in the second direction, causing the panels of the first sub-assembly to pivot in the second direction of rotation.

In all the configurations where the row of panels forms a continuous covering in the covering position, such a sequence advantageously avoids any contact between adjacent panels when the intention is for the inclination of the panels to transition from one side of the covering position to the other. The row of tiltable panels then can be oriented in a direction that is initially inaccessible. This is particularly true when, in the covering position, the panels in the row partially overlap.

According to one embodiment, the control is a function of one or more of the following parameters: a shading setpoint; a position of a predetermined light and/or heat source, preferably the sun; one or more environmental parameters, for example, wind strength, wind direction, precipitation intensity, and/or ambient temperature.

It is then possible to fine-tune the positioning of the tiltable panels associated with either of the two sub-assemblies, so that said tiltable panels fulfill their assigned function, for example, energy production and/or protection of the ground beneath the installation.

Preferably, the tiltable panels of the first sub-assembly are controlled independently of the tiltable panels of the second sub-assembly. Similarly, the tiltable panels of the second sub-assembly are preferably controlled independently of the tiltable panels of the first sub-assembly.

According to another aspect of the invention, the invention also relates to a control device configured to implement the steps of the control method as described above, with the control device being characterized in that it comprises at least one microcontroller intended to be connected to a first motor for pulling the first control cable and, if applicable, to a second motor for pulling a second control cable, and in that the microcontroller is connected to one or more sensors selected from among the following sensors: a brightness sensor; a humidity sensor; a movement sensor; a position sensor; an electric current or voltage sensor placed in a circuit comprising at least one active element of at least one of the tiltable panels of the first sub-assembly.

A further aspect of the invention is a computer program product comprising instructions, executable by the control device comprising a microprocessor or a microcontroller, for implementing the control method as described above, when it is executed by said microprocessor or microcontroller.

### BRIEF DESCRIPTION OF THE FIGURES

Other features and advantages of the invention will become apparent on reading the following description, with reference to the appended figures, which show:

FIG. 1 is a schematic side view of a solar installation comprising a row of tiltable panels according to the invention, according to a first embodiment.

FIG. 2 is an isometric schematic view of the row of panels according to the first embodiment.

FIG. 3A is a schematic view of three successive tiltable panels of the row of panels, in a first position, called covering position, according to the first embodiment.

FIG. 3B is a schematic view of three successive tiltable panels of the row of panels, in a second position, according to the first embodiment.

FIG. 3C is a schematic view of three successive tiltable panels of the row of panels, in a third position, according to the first embodiment.

FIG. 3D is a schematic view of three successive tiltable panels of the row of panels, in a fourth position, according to the first embodiment.

FIG. 3E is a schematic view of three successive tiltable panels of the row of panels, in a fifth position, according to the first embodiment.

FIG. 3F is a schematic view of three successive tiltable panels of the row of panels, in a sixth position, called covering position, according to the first embodiment.

FIG. 4A is a schematic view of three successive tiltable panels of the row of panels, in a first position, called covering position, according to a second embodiment.

FIG. 4B is a schematic view of three successive tiltable panels of the row of panels, in a second position, according to the second embodiment.

FIG. 4C is a schematic view of three successive tiltable panels of the row of panels, in a third position, according to the second embodiment.

FIG. 4D is a schematic view of three successive tiltable panels of the row of panels, in a fourth position, according to the second embodiment.

FIG. 4E is a schematic view of three successive tiltable panels of the row of panels, in a fifth position, according to the second embodiment.

FIG. 4F is a schematic view of three successive tiltable panels of the row of panels, in a sixth position, according to the second embodiment.

FIG. 5 is a schematic view of three successive tiltable panels of a row of panels, in a first position, called covering position, according to a third embodiment.

FIG. 6 is a schematic side view of a solar installation comprising a row of tiltable panels, according to a fourth embodiment.

FIG. 7 is a schematic side view of a solar installation comprising a row of tiltable panels, according to a fifth embodiment.

FIG. 8 is a schematic view of three successive tiltable panels of a row of panels of a solar installation according to a sixth embodiment.

FIG. 9 is a schematic view of three successive tiltable panels of a row of panels of a solar installation according to a seventh embodiment.

FIG. 10 is a schematic view of three successive tiltable panels of a row of panels of a solar installation according to an eighth embodiment, in a position, called covering position.

FIG. 11 is a schematic view of three successive tiltable panels of the row of panels of the solar installation according to the eighth embodiment, in a second solar capturing position.

For greater clarity, identical or similar elements are identified by identical reference signs in all of the Figures.

### DETAILED DESCRIPTION

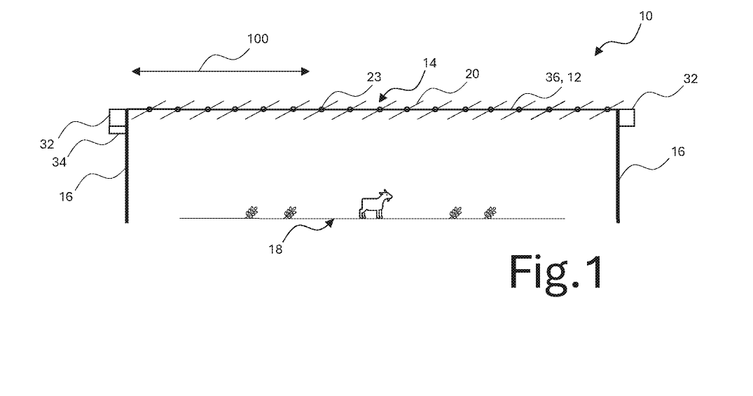

FIG. 1 illustrates a solar installation 10 according to a first embodiment comprising a supporting structure 36 configured to support at least one row of panels 14 and extending in a reference direction 100 between at least two pylons 16 of the supporting structure 36. Here, the row of panels 14 is arranged at a distance above agricultural land 18, but it is also possible to cover other types of ground, for example car parking lots.

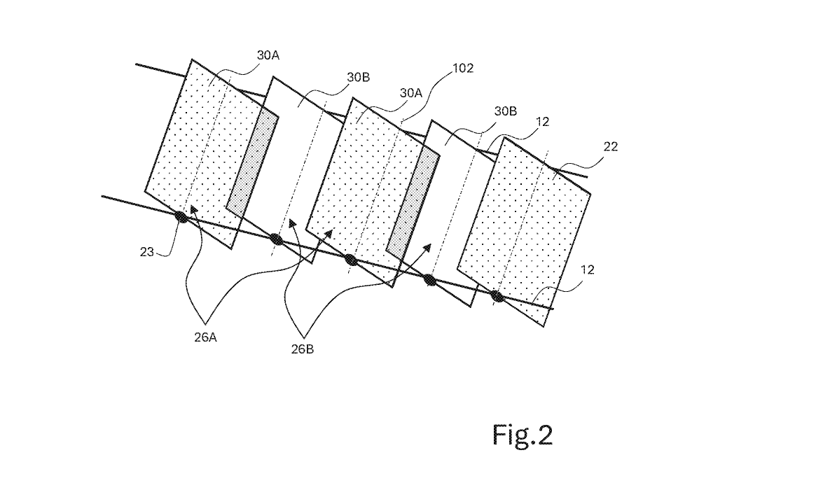

As shown in particular in FIG. 2, the supporting structure 36 comprises, for example, two support cables 12. The two support cables 12 extend between at least the two pylons 16 and are parallel to each other. In this embodiment, the support cables 12 are generally parallel to a level line, that is, the two ends of the two cables 12 have a negligible elevation differential as a function of the length of said support cables 12. The support cables 12 are parallel to the reference direction 100. The support cables 12 are made of one or more materials configured to withstand high loads over a long period of time while being subjected to outdoor weather conditions. In this way, the support cables 12 each have a predetermined composition, structure and cross-sectional dimension to withstand the conditions to which said cables 12 are subjected.

The row of panels 14 comprises a plurality of tiltable panels 20, at least some of which, as will be described later, are solar, photovoltaic or solar thermal panels. Each tiltable panel 20 comprises a generally rectangular body 22 pivotally mounted on two associated pivots 23, fixed to the two support cables 12 and aligned on an associated pivoting axis 102 which is locally perpendicular to the two support cables 12. The body 22 extends longitudinally between the two support cables 12. Each body 22 of a tiltable panel 20 comprises an upper face 24 opposite a lower face of the same tiltable panel 20. Each pivoting axis 102 preferably passes through the center of mass of the associated tiltable panel 20, and, assuming a uniform distribution of the mass of the panel body 22, splits the body 22 of the tiltable panel 20 into two equal parts). As a result, the energy required to pivot each tiltable panel 20 is minimal.

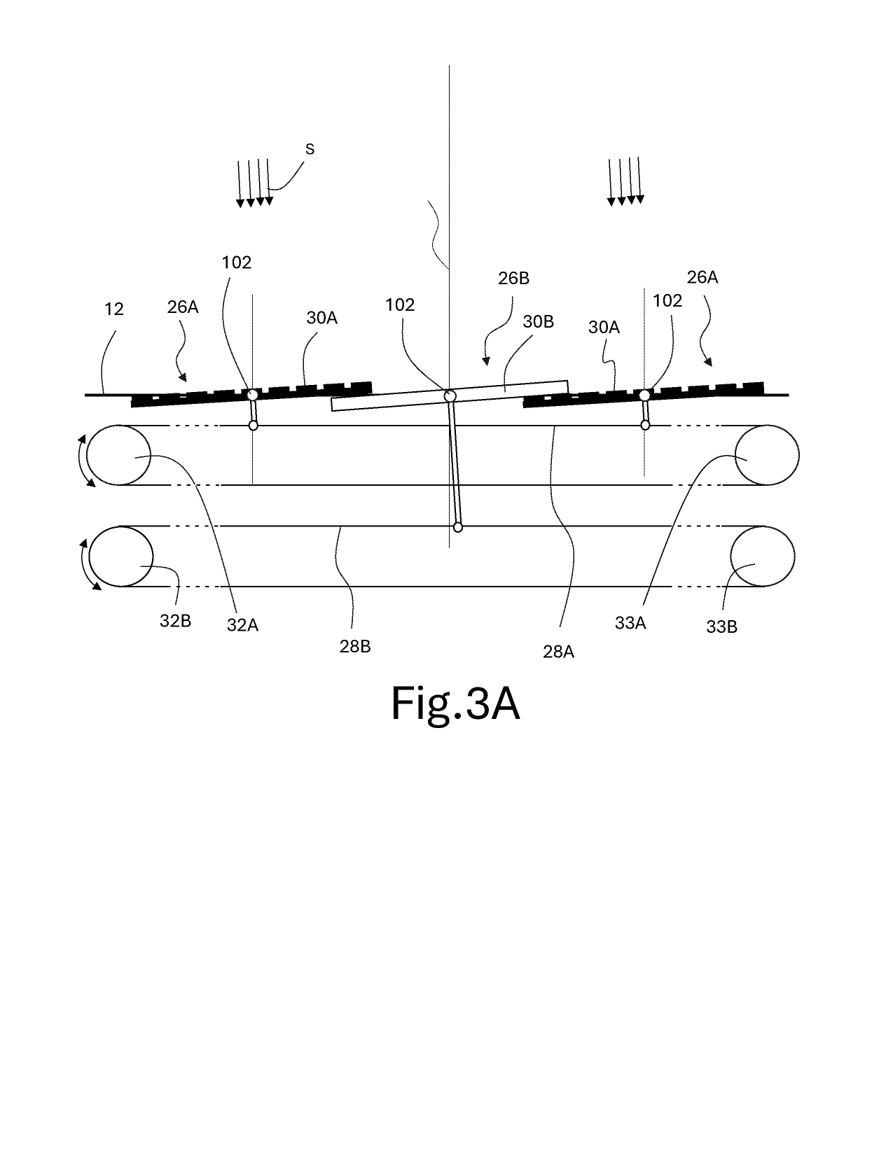

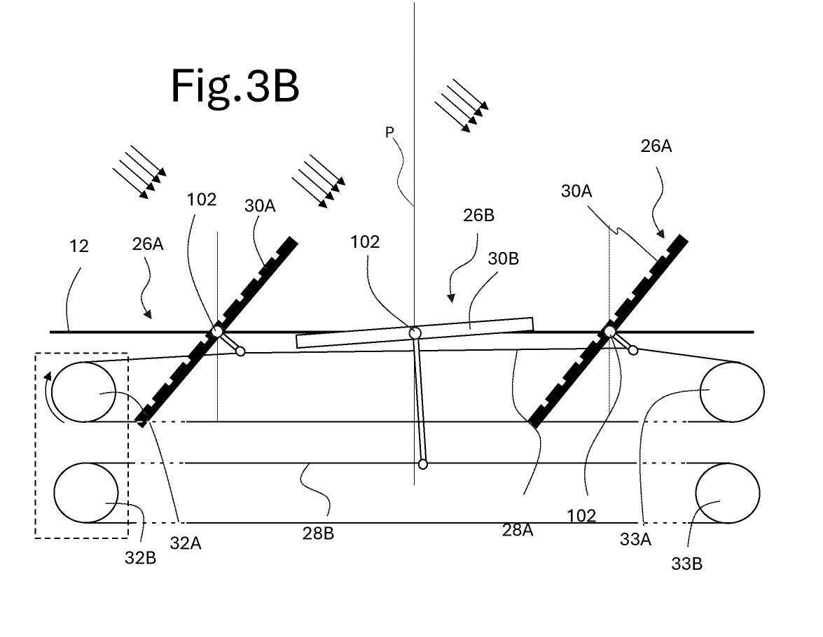

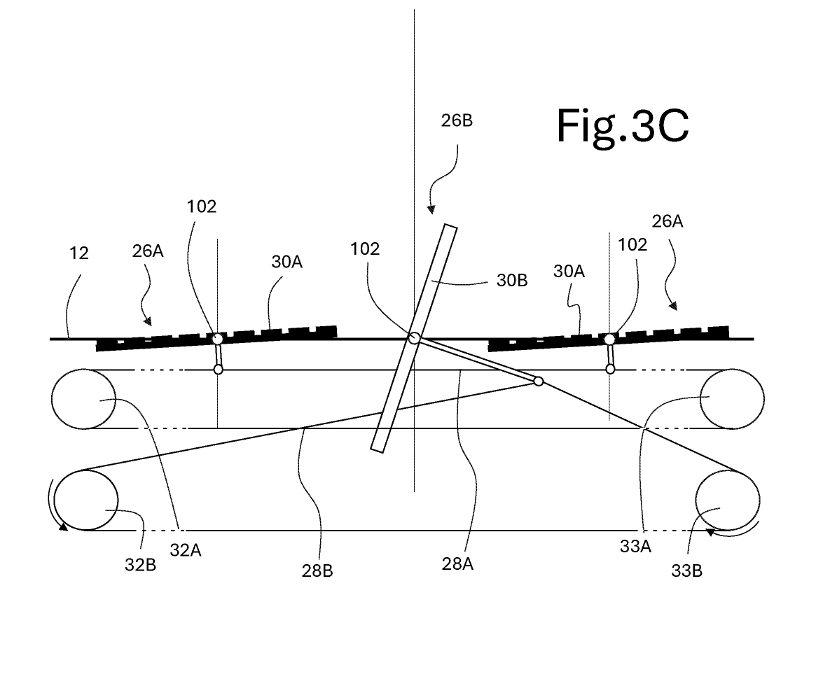

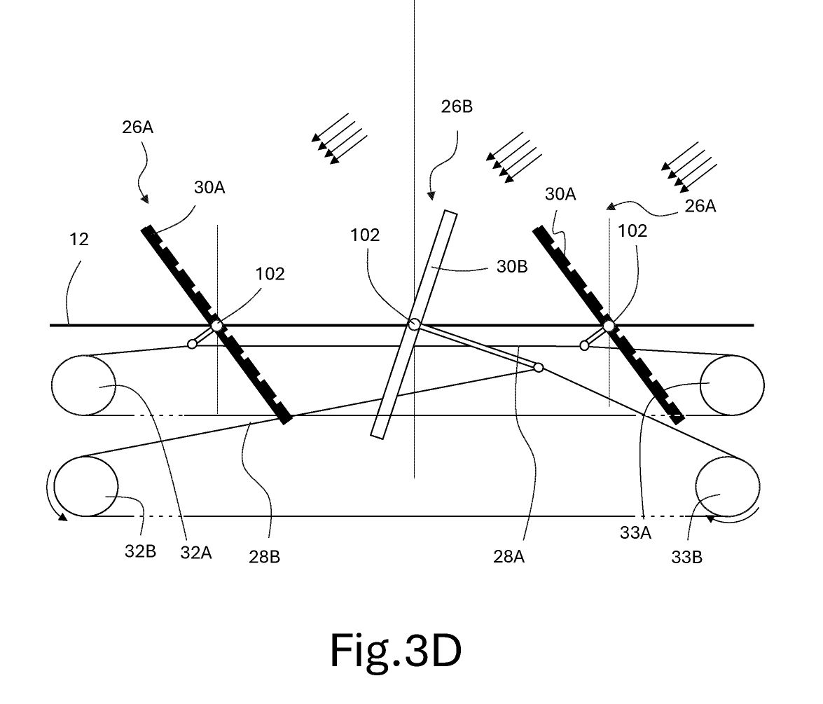

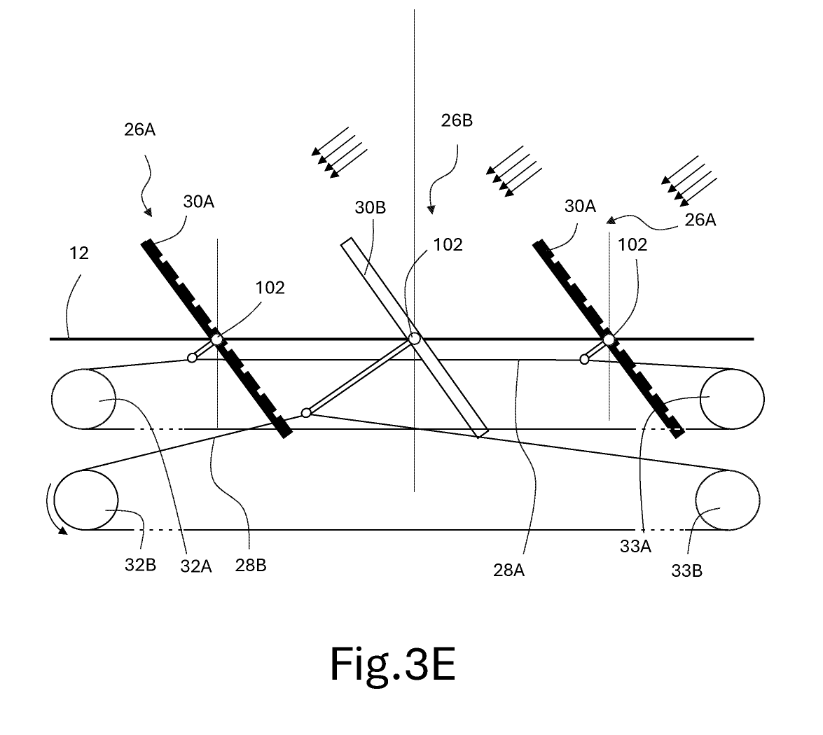

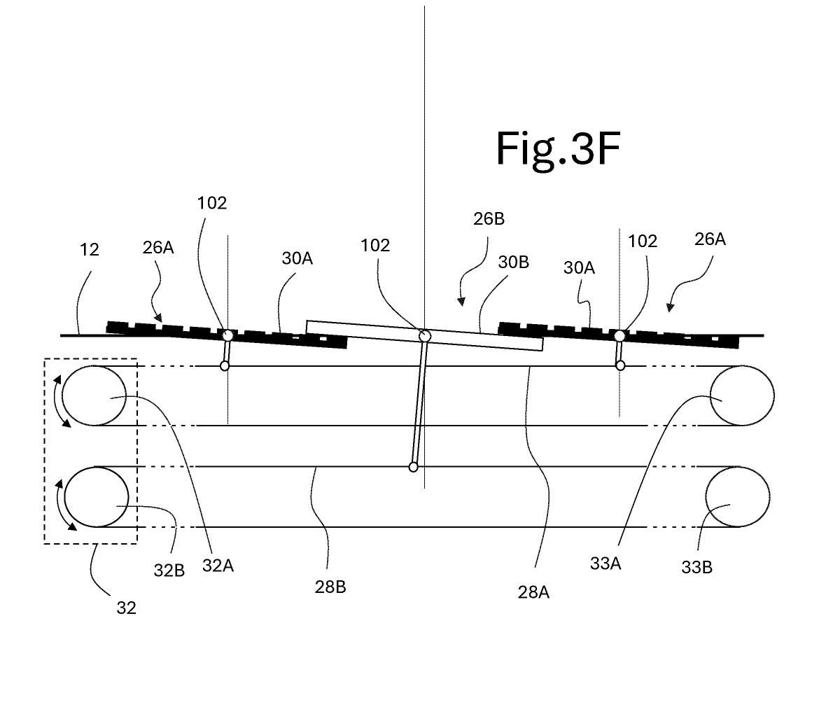

With reference to FIGS. 3A-3E, the tiltable panels 20 are free to rotate about the pivoting axis 102 in a predetermined angular sector of more than 45°, and preferably of more than 60° C, for example, of the order of 90°, on both sides of a reference position in which the upper face 24 is parallel to the pivoting axis 102 and to the reference direction 100. Thus, each tiltable panel 20 can assume at least one position, called “covering” position (in this case two covering positions, exemplified in FIGS. 3A and 3F, close to the reference position) and “open” positions (for example, exemplified in FIGS. 3B or 3D).

In this embodiment, two pivoting axes of successive tiltable panels 20 are spaced apart by a predetermined distance greater than half the width of a panel and less than the width of a panel, this width being the dimension of the upper face 24 perpendicular to the pivoting axis 102. Thus, in the covering positions exemplified in FIGS. 3A and 3E, the two adjacent tiltable panels 20 partially overlap. The row of panels 14 then continuously covers the underlying ground.

The tiltable panels 20 are divided into two sub-assemblies 26A, 26B.

A first sub-assembly 26A consists of tiltable panels 20 linked to a first control cable 28A, so that pulling on the first control cable 28A in a given direction causes the tiltable panels 20 of the first sub-assembly 26A to pivot about their respective pivoting axes 102. The tiltable panels 20 of the first sub-assembly 26A each feature at least one photovoltaic and/or solar thermal active element 30A positioned on the upper face 24 of the body 22. In this case, in this embodiment, the active element or elements 30A cover the entire upper face 24 of the body 22.

A second sub-assembly 26B, separate from the first sub-assembly 26A, consists of tiltable panels 20 linked to a second control cable 28B, so that pulling on the second control cable 28B in a given direction causes the tiltable panels 20 of the second sub-assembly 26A to pivot about their respective pivoting axes 102. In this embodiment, the body 22 of the tiltable panels 20 of the second sub-assembly 26B comprises at least one transparent portion 30B and does not comprise a photovoltaic and/or solar thermal active element 30A. In this case, the tiltable panels 20 of the second sub-assembly 26B are completely transparent. Transparency is understood here and throughout the application to mean a transparency that extends into the useful spectrum for the active elements 30A, for example between 350 nm and 1200 nm. Preferably, the transparent portion 30B is no longer transparent in the mid-infrared spectrum corresponding to the emission wavelengths of ground radiation, especially in the range of wavelengths comprised between 3 µm and 60 µm.

In this embodiment, the first cable 28A forms a first cable loop stretched between a first bidirectional drive pulley 32A and a first receiving pulley 33A. Similarly, the second cable 28B forms a second cable loop stretched between a second bidirectional drive pulley 32B and a second receiving pulley 33A.

The drive pulleys 32A and 32B belong to a motorized assembly 32 controlled by a control device 34. The control device 34 comprises, for example, a microprocessor or a microcontroller. The control device 34 is configured to implement a method for driving the tiltable panels 20, and thus control the motorized elements 32 to drive the tiltable panels 20. The control device 34 can be connected to a clock and a memory which can contain, for example, an abacus indicating the position of the sun as a function of the day of the year and the time of day, or, to put it another way, the tilt of the panels to ensure maximum sunlight.

The control device 34 can also be connected to various sensors. The installation comprises, by way of example, a brightness sensor, a precipitation detector, an anemometer, a motion sensor, a position sensor and/or an electric current or voltage sensor connected to one or more of the photovoltaic panels among the tiltable panels 20. These measurement elements are configured to collect information characterizing an environmental situation at a specific point in time. Information is collected periodically, for example every 15 minutes. The control device 34 can then control the tiltable panels 20 after determining the environmental situation, based on the information gathered by the measuring elements.

In this embodiment, the tiltable panels 20 of the two sub-assemblies 26A, 26B are arranged alternately along the two support cables 12 to form the row of panels 14. In other words, two successive active tiltable panels 20 of the first sub-assembly 26A are separated by a transparent tiltable panel 20 of the second sub-assembly 26B, and two successive transparent tiltable panels 20 of the second sub-assembly 26A are separated by an active tiltable panel 20 of the first sub-assembly 26B.

The operation of the system is exemplified in FIGS. 3A-3E. In FIG. 3A, the tiltable panels 20 are in a covering position, for example to protect the underlying ground from precipitation, or to limit radiative cooling of the ground. In this covering position, the coverage offered by the tiltable panels 20 is continuous and the panels are partially overlapping. This position will also be adopted for optimum orientation of the active elements 30A, when the direction of the solar rays S is perpendicular to the upper surface 24 of the panels 20 in the covering position.

To follow the sun, the panels 20 of the first sub-assembly 26A can be tilted from the position of FIG. 3A to the position exemplified in FIG. 3B by actuating the drive pulley 32A, without the need to drive the second sub-assembly 26B.

When intending, by contrast, starting from the position of FIG. 3A, to tilt the panels 20 of the first sub-assembly 26A into the position of FIG. 3D, an intermediate step needs to be followed, as exemplified in FIG. 3C, in which the panels 20 of the second sub-assembly 26B are tilted, by actuating the drive pulley 32B, into a retracted position that allows the panels 20 of the first sub-assembly to pass through.

If required, a second covering position can be obtained, exemplified in FIG. 3F, which requires, starting from the position in FIG. 3D, first tilting the tiltable panels 20 of the second sub-assembly 26B into the position in FIG. 3E by actuating the drive pulley 32B, then simultaneously actuating the pulleys 32A and 32B to reach the covering position in FIG. 3F.

The transparent tiltable panels 20 of the second sub-assembly 26B interposed between the active elements 30A borne by the tiltable panels 20 of the first sub-assembly allow, in the tilted positions of FIGS. 3B, 3D and 3E, the entirety of the active elements 30A to be exposed to the incident solar rays, without creating an area of shadow. The same applies to the covering positions of FIGS. 3A and 3F, where covering part of the active elements with transparent panels is not a disadvantage. In this way, the installation combines optimum use of the active elements 30A, which can be oriented towards the incident rays and are not subject to areas of shadow, with seamless coverage in the covering positions of FIGS. 3A and 3F. The row of tiltable panels 14 according to the first embodiment therefore allows, via the mobility of the tiltable panels 20:
Optimum shade-free orientation of the tiltable panels, so that the 30A active elements are perpendicular to the incident solar rays, to optimize photovoltaic or solar thermal yield in production phases
Covering positions to protect the underlying ground in the event of precipitation or at night;
Wind protection positions, wherein the panels are positioned to minimize their exposure to the wind.

In addition, the presence of transparent portions 30B interposed between the active elements 30A, allows areas of shadow to be avoided when the active elements 30A are tilted, which optimizes, for a given surface area of active elements 30A, the recovery of the solar energy.

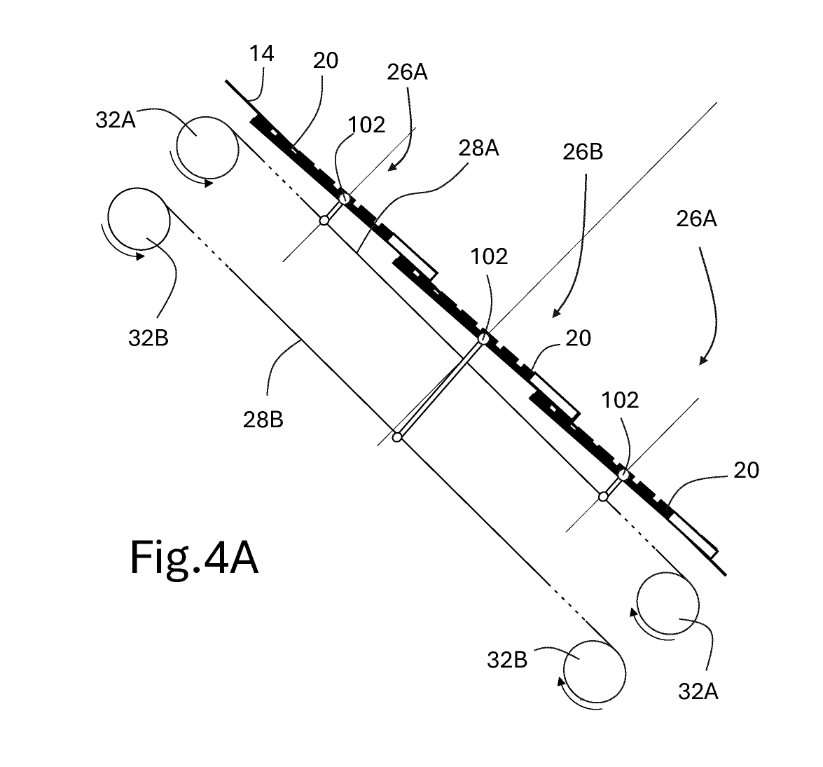

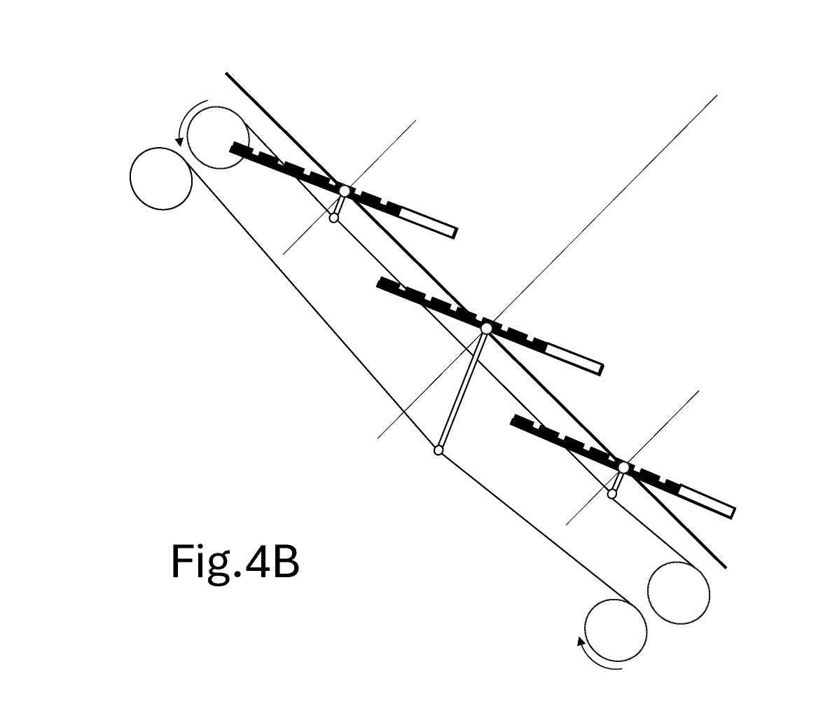

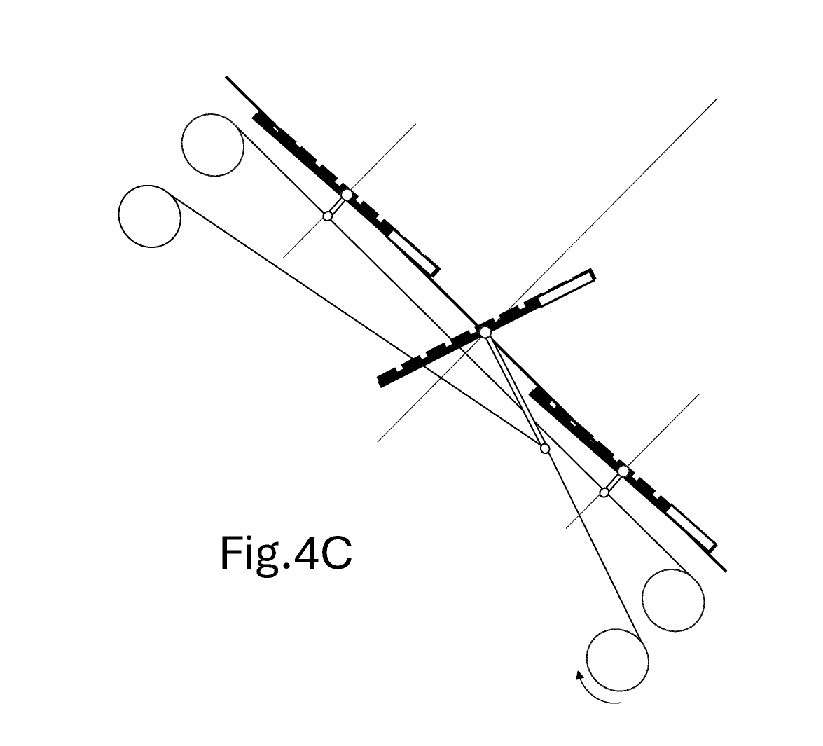

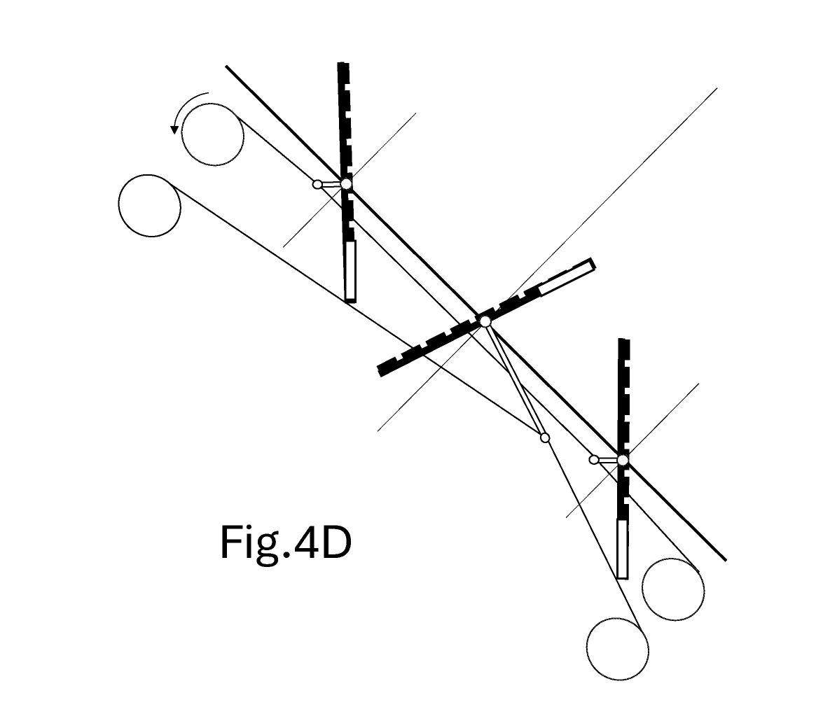

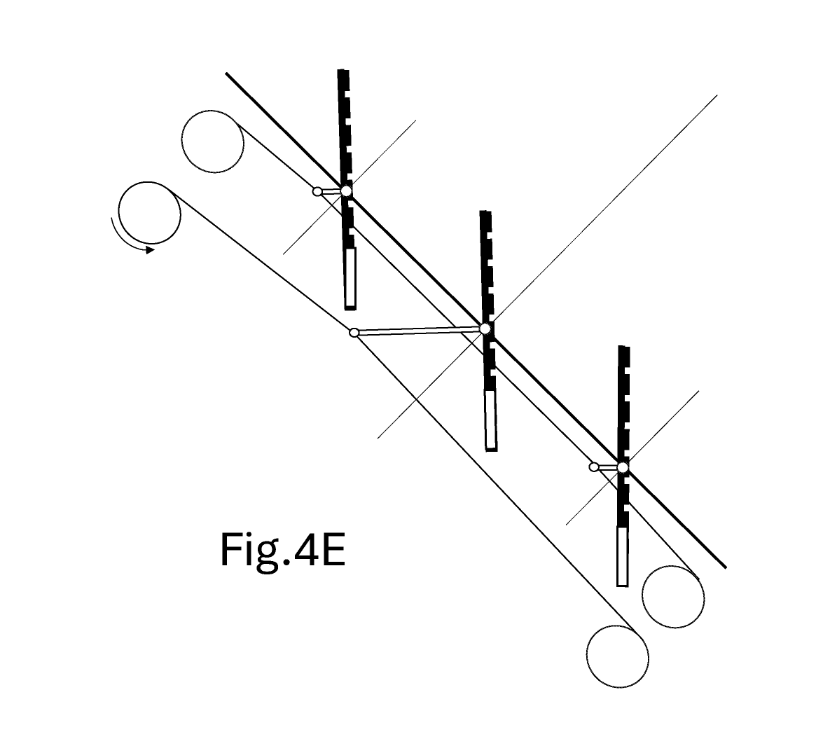

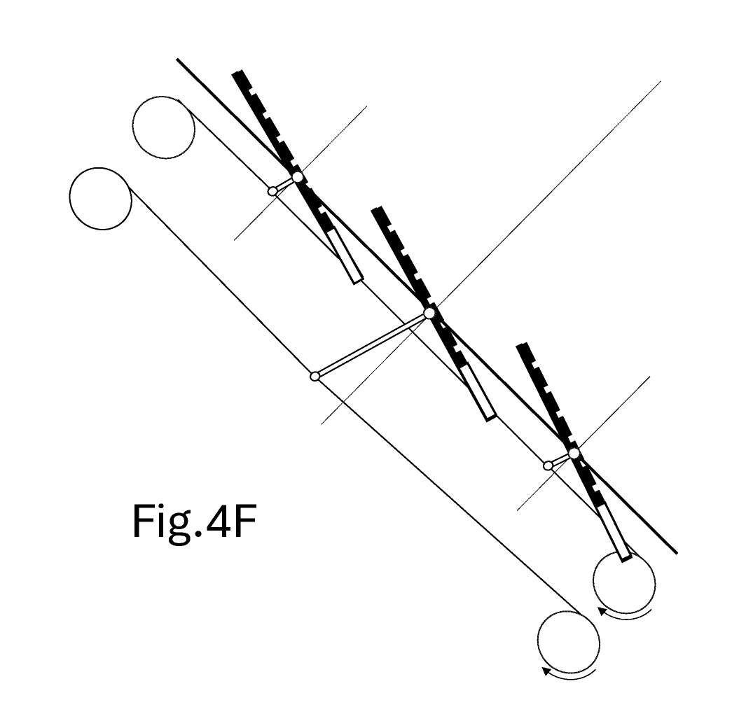

A second embodiment, exemplified in FIGS. 4A-4D, differs from the first embodiment in the following respects:
The reference direction 100 defined by the supporting structure 36 is inclined, for example because the installation is positioned on sloping ground. This tilt is very pronounced on FIGS. 4A-4D, and can be less pronounced if required.
The tiltable panels 20 of the first sub-assembly 26A comprise both at least one photovoltaic or solar thermal active element 30A and at least one transparent portion 30B. In the reference position where the tiltable panel is parallel to the reference direction 100, or in the covering position of FIG. 4A which is close to it, the active element 30A occupies the upper part of the tiltable panel 20 and the transparent portion 30B occupies the lower part of the tiltable panel 20.
The panels 20 of the second sub-assembly 26B comprise both at least one photovoltaic or solar thermal active element 30A and at least one transparent portion 30B. In the reference position where the tiltable panel is parallel to the reference direction 100, or in the covering position of FIG. 4A which is close to it, the active element 30A occupies the upper part of the tiltable panel 20 and the transparent portion 30B occupies the lower part of the tiltable panel 20.
the first cable 28A consists of a cable whose ends are wound on two opposing motor drums 32A, each capable of pulling the first cable 28A in one direction;
the second cable 28B consists of a cable the ends of which are wound on two opposing motor drums 32B, each capable of pulling the second cable 28B in one direction.

The installation according to this second embodiment operates as follows.

In the covering position of FIG. 4A, the tiltable panels of the two sub-assemblies 26A and 26B form a seamless shingle arrangement, with the top part of the active elements 30A covered by the transparent portion 30B of an adjacent tiltable panel. In this position, precipitation flows naturally by gravity from one tiltable panel to the other. The part covered by the active elements 30A nevertheless performs its function of capturing solar energy, by virtue of the transparency of the transparent portions 30B.

The transition from the covering position of FIG. 4A to a less inclined position of the panels 20 is performed by actuating the drum motors 32A and 32B as depicted in FIG. 4B.

The transition from the covering position of FIG. 4A to the more inclined position of FIG. 4F requires two transitional intermediate stages exemplified in FIGS. 4C, 4D and 4E, namely a sequence in which firstly (FIG. 4C) the tiltable panels 20 of the second sub-assembly 26B are positioned so as to retract, and secondly (FIG. 4D) to leave the passage clear for the tiltable panels 20 of the first sub-assembly 26A until these are positioned in a transitional position which allows the tiltable panels of the second sub-assembly 26B to be turned over to the position of FIG. 4E, before all the panels can finally be brought into the desired final position of FIG. 4F. In the position of FIG. 4F, the upper part of the active elements 30A casts a shadow on the tiltable panel 20 immediately above in the row of panels 14, but only in the transparent portion 30B, so that the active elements 30A receive full sunlight.

The tilt of the tiltable panels 20 can be controlled according to the declination of the sun, over the course of the year and/or the day. The tilt of the tiltable panels in the covering position of FIG. 4A is chosen, for example, to obtain the best performance on the day of the equinox. The tilt in the position of FIG. 4B is chosen, for example, for each day in spring or summer to obtain the best daytime performance, and the inclination in the position of FIG. 4F is chosen, for example, for each day in autumn or winter to obtain the best daytime performance.

The common feature of the first and second embodiments is that the tiltable panels 20 of the second sub-assembly 26B are interposed between the tiltable panels 20 of the first sub-assembly 26A, allowing, inter alia, the tiltable panels 20 of row 14 to overlap two-by-two in the covering position, while at the same time allowing the tiltable panels 20 to be tilted in both directions with respect to the covering position.

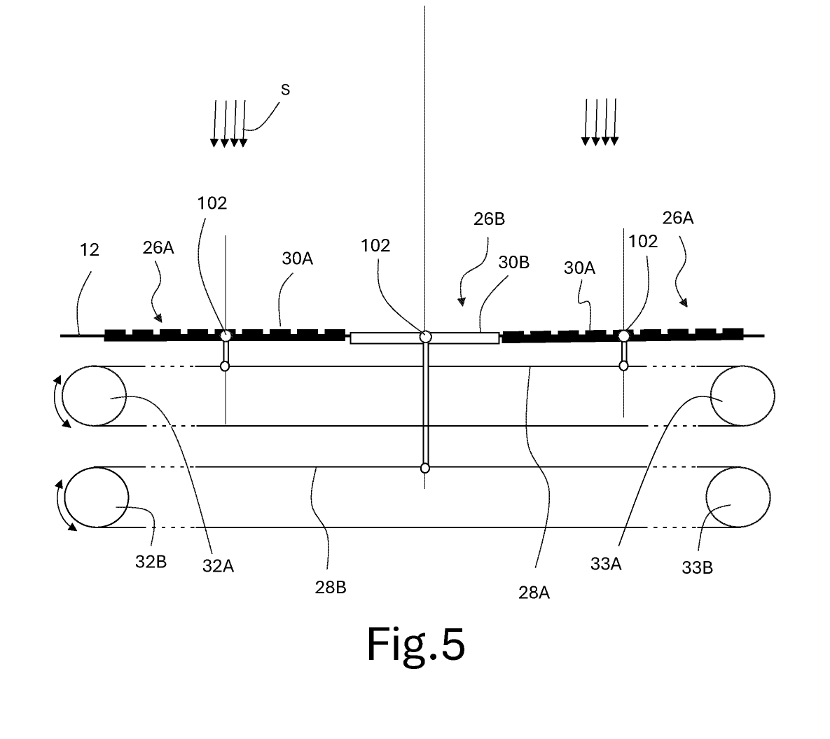

The same advantage is obtained when, as an alternative to the first and second embodiments, the tiltable panels 20 of the two sub-assemblies 26A, 26B are arranged end-to-end in the covering position, without overlapping, according to a third embodiment exemplified, for example, in FIG. 5 in the covering position. In this configuration, the same activation sequences are used as in previous embodiments, to avoid contact when moving from one side to the other of a covering position.

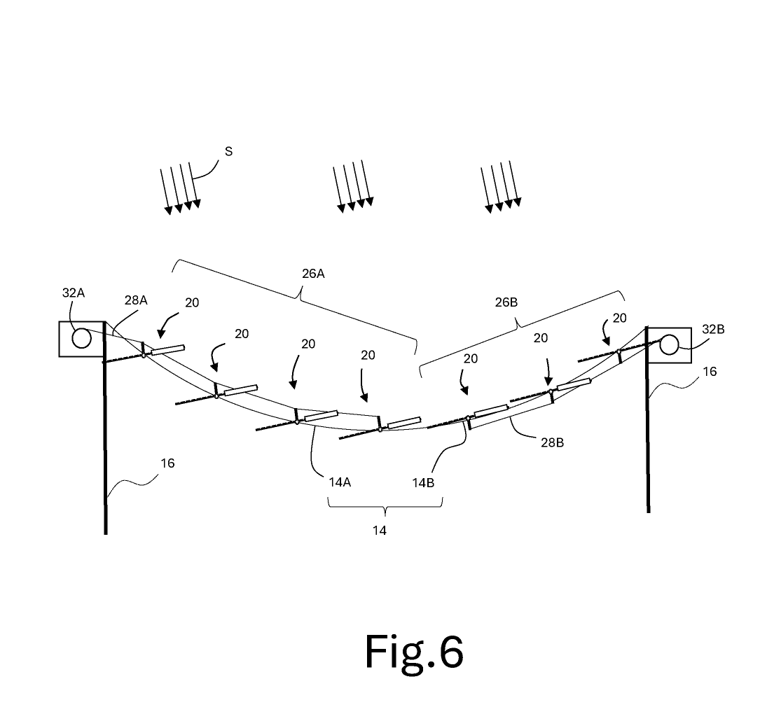

The installation according to the fourth embodiment of FIG. 6 differs from the previous ones in that the tiltable panels 20A of the first sub-assembly 26A are arranged side-by-side along a first part 14A of a supporting chain cable, whereas the tiltable panels 20 of the second sub-assembly 26B are arranged side-by-side along a second part 14B of the supporting chain cable, the parts of the support cable 12 having different slopes, here in opposite directions, which justify controlling the tilt of each sub-assembly 26A, 26B independently, to orientate the assembly of tiltable panels 20 appropriately according to the incident solar rays. As in the second embodiment of FIGS. 4A-4F, it can be provided that each of the tiltable panels 20 comprises an active element 32A and a transparent portion 32B, so that the tiltable panels do not cast a shadow on the active elements 32A of the tiltable panels 20 next along in the row, which would reduce the efficiency of the installation.

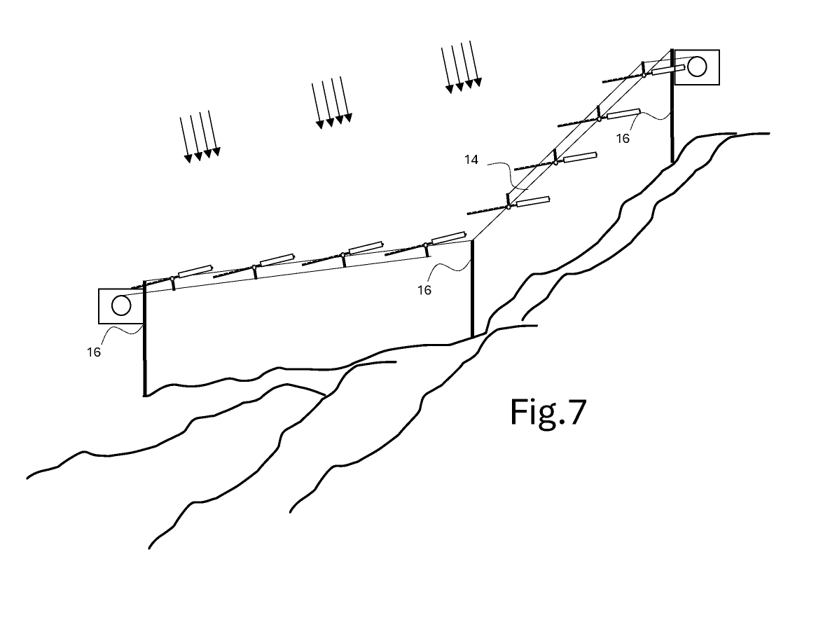

A further example of such an arrangement is provided by the fifth embodiment exemplified in FIG. 7, which differs from the previous one substantially in that the installation equips a site with a variable slope, which is the cause of the difference in slope between the first part 14A of the support cable and the second part 14B of the support cable. The common feature of the installations of FIGS. 6 and 7 is that they are not necessarily covering, in the sense that a sufficient distance is provided between the panels to prevent them from colliding. If required, however, a covering version can be provided as an alternative, provided that precautions are taken to restrict the angular deflection of each sub-assembly 26A, 26B to one side of the covering position only.

More generally, this embodiment illustrates that the invention can have as many strands of control cables as there are portions of rows of tiltable panels 14 following different lines of slope, and as many distinct sub-assemblies of panels 20 as there are strands of control cables.

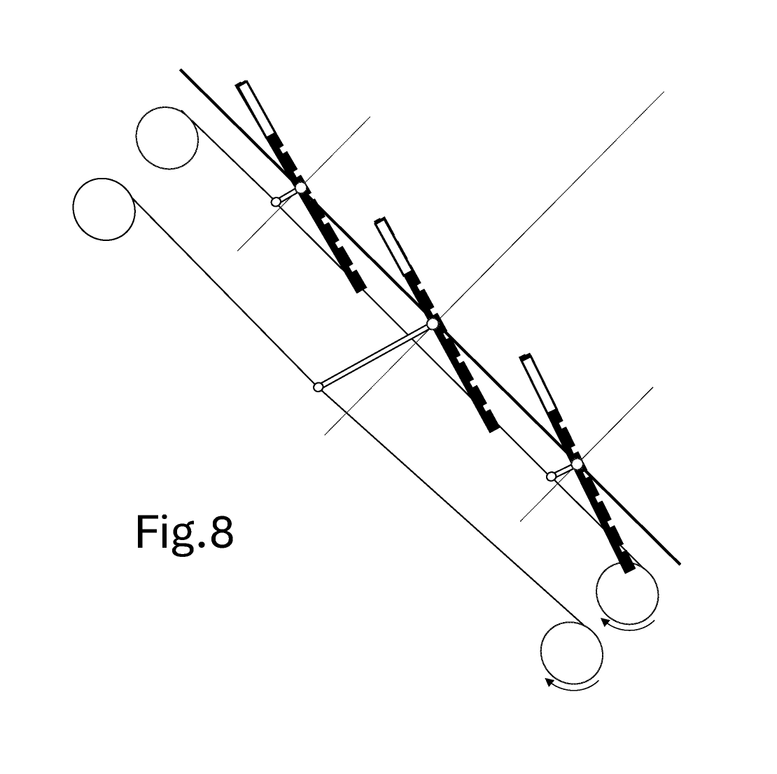

A sixth embodiment, exemplified in FIG. 8, differs from the second embodiment in that the transparent portions 30B are arranged in the upper part of the tiltable panels 20.

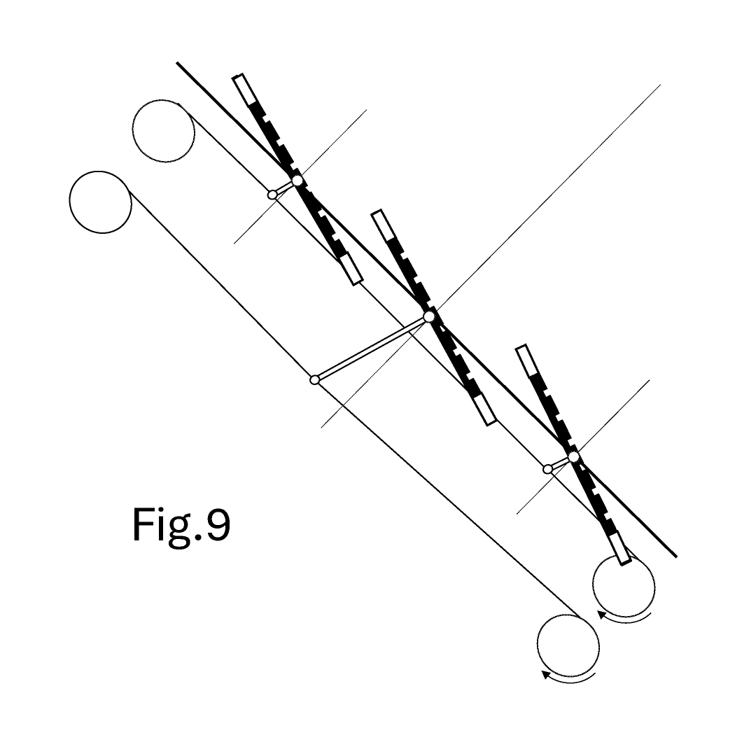

A seventh embodiment, exemplified in FIG. 9, differs from the second embodiment in that the tiltable panels 20 of the first and second sub-assemblies 26B each comprise an active element 30A framed by two transparent portions 30B.

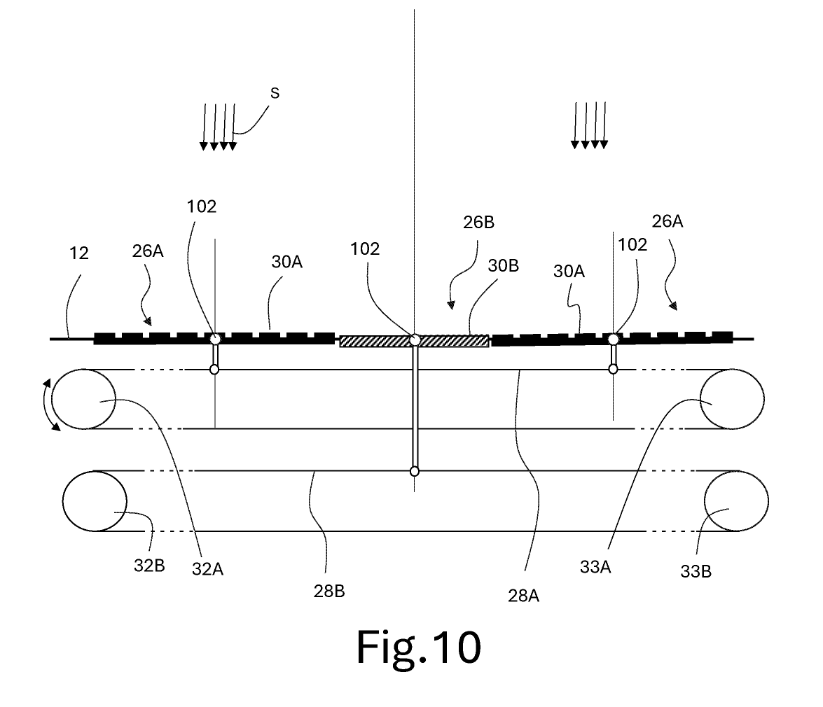

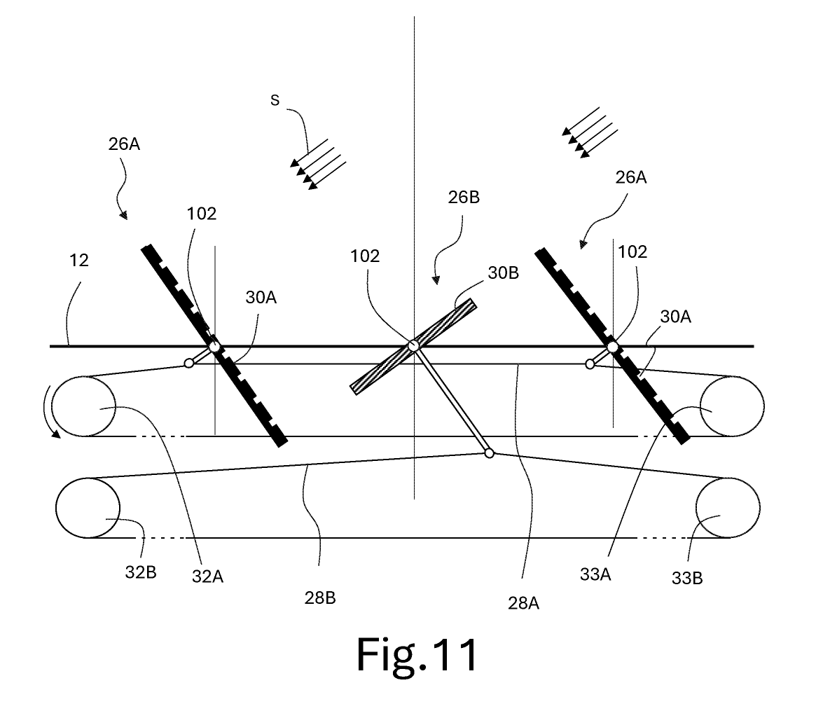

An eighth embodiment exemplified in FIGS. 10 and 11, as a variant of the third embodiment shown in FIG. 5, differs from the previous ones in that the tiltable panels 20 of the second sub-assembly 26B are opaque. In the phases for capturing incident solar energy, the tiltable panels 20 of the second sub-assembly 26B are oriented so as to minimize their cast shadow, therefore, at right angles to the tiltable panels of the first sub-assembly 26A, as illustrated in FIG. 11. If applicable, the tiltable panels 20 of the second sub-assembly 26B can be reflective, for example, made up of mirrors, which can be oriented, if applicable, to reflect all or some of the tiltable panels of the first sub-assembly 26A. Such an arrangement is particularly advantageous if the tiltable panels 20 of the first sub-assembly 26A are bifacial, in the sense that they are capable of producing energy from radiation equally arriving on their upper or lower face.

A ninth embodiment, not shown, differs from the previous embodiments in that the pivots 23 define a pivoting axis 102 that is offset with respect to the center of gravity of the panels 20 and with respect to the geometric barycenter of the panels 20. The pivoting axis 102 can, for example, coincide with an edge of the panel extending from one of the support cables 12 to the other, or at least be closer to such an edge than to the center of gravity of the panel 20. This may be true for all the tiltable panels 20, or for some of them only, for example the tiltable panels 20 of the first sub-assembly 26A or those of the second sub-assembly 26B.

A tenth embodiment, not shown, differs from the previous embodiments in that all or some of the tiltable panels 20, for example, the tiltable panels 20 of the first sub-assembly 26A or those of the second sub-assembly 26B, have, along a transverse edge, a water collection element, for example, a gutter.

Of course, the invention is described in the foregoing by way of example. It is understood that a person skilled in the art is able to produce different variant embodiments of the invention without departing from the scope of the invention.

The tiltable panels 20 can be suspended not by support cables but directly by pylons arranged under the tiltable panels 20.

1. A solar installation comprising:
a supporting structure parallel to a reference direction, and
a row of panels arranged along the reference direction, each of the panels being suspended by the supporting structure, the row of panels comprising at least one first sub-assembly of tiltable panels, which are each tiltable at least between a covering position and an open position by pivoting about a pivoting axis perpendicular to the reference direction and which each comprise at least one photovoltaic and/or solar thermal active element, with a first pivoting control cable extending parallel to the reference direction being connected to the tiltable panels of the first sub-assembly of tiltable panels, the row of panels further comprising at least one second sub-assembly of tiltable panels, which are each tiltable at least between a covering position and an open position by pivoting about a pivoting axis perpendicular to the reference direction, with a second pivoting control cable extending parallel to the reference direction being connected to the tiltable panels of the second sub-assembly of tiltable panels, the first and second sub-assemblies of tiltable panels being separate.

2. The solar installation of claim 1, wherein, in the covering position, the row of panels forms a continuous cover.

3. The solar installation of claim 2, wherein, in the covering position, the tiltable panels partially overlap and form a shingle arrangement along a reference position.

4. The solar installation of claim 2, wherein, in the covering position, the tiltable panels come into contact with each other without overlapping along the reference direction.

5. The solar installation of claim 1, wherein, in the covering position, the tiltable panels are spaced apart from one another.

6. The solar installation of claim 1, wherein any two successive tiltable panels of the first sub-assembly of tiltable panels are separated by a tiltable panel of the second sub-assembly of tiltable panels, and any two successive tiltable panels of the second sub-assembly of tiltable panels are separated by a tiltable panel of the first sub-assembly of tiltable panels.

7. The solar installation of claim 1, wherein the tiltable panels of the second sub-assembly of tiltable panels each comprise at least one photovoltaic and/or solar thermal active element.

8. The solar installation of claim 1, wherein at least some of the tiltable panels of the second sub-assembly of tiltable panels do not comprise photovoltaic and/or solar thermal active elements.

9. The solar installation of claim 1, wherein the row of panels comprises at least one sub-assembly of non-concealing panels, each comprising at least one fully transparent portion, which, in the covering position, allows incident light to pass through said non-concealing panels, the sub-assembly of non-concealing panels being able to include all or some of the first sub-assembly of tiltable panels and/or of the second sub-assembly of tiltable panels.

10. The solar installation of claim 1, further comprising at least one first motor for pulling the first control cable.

11. The solar installation of claim 10, further comprising at least one second motor for pulling the second control cable.

12. The solar installation of claim 10, further comprising a control device capable of controlling the first motor as a function of one or more signals originating from one or more sensors, selected from among the following sensors:
a brightness sensor;
a humidity sensor;
a motion sensor;
a position sensor;
an electric current or voltage sensor located in a circuit comprising at least one active element of at least one of the tiltable panels of the first sub-assembly.

13. A method for controlling a solar installation of claim 1, the method comprising a step (S10) of pulling the first control cable, so as to set into rotation the first sub-assembly associated with said control cable.

14. The control method of claim 13, further comprising a step of pulling the second cable, so as to drive the second control cable.

15. The control method of claim 13, wherein, starting from the covering position, the control method comprises an opening sequence comprising:
a step of pulling the first cable in a first direction, causing the panels of the first sub-assembly to pivot in a first direction of rotation; then
a step of pulling the second cable in a second direction, causing the panels of the second sub-assembly to pivot in a second direction of rotation; then
a step of pulling the first cable in the second direction, causing the panels of the first sub-assembly to pivot in the second direction of rotation.

16. The control method of claim 15, wherein the control is a function of one or more of the following parameters:
a shading setpoint;
a position of a predetermined light and/or heat source;
one or more environmental parameters, such as wind strength, wind direction, precipitation intensity and/or ambient temperature.

17. A control device configured to implement the steps of the control method of claim 13, the control device comprising at least one microcontroller intended to be connected to a first motor for pulling the first control cable and, if applicable, to a second motor for pulling a second control cable, and in that the microcontroller is connected to one or more sensors selected from among the following sensors:
a brightness sensor;
a humidity sensor;
a motion sensor;
a position sensor;
an electric current or voltage sensor located in a circuit comprising at least one active element of at least one of the tiltable panels of the first sub-assembly.

18. The solar installation of claim 11, further comprising a control device capable of controlling the first motor and the second motor as a function of one or more signals originating from one or more sensors, selected from among the following sensors:
a brightness sensor;
a humidity sensor;
a motion sensor;
a position sensor;
an electric current or voltage sensor located in a circuit comprising at least one active element of at least one of the tiltable panels of the first sub-assembly.
